(19) United States
(12) Patent Application Publication
(10) Pub. No.: US 2015/0086286 A1
(43) Pub. Date: Mar. 26, 2015

(54) Electric Power Tool

(71) Applicant: Jack A. Ekchian, Belmont, MA (US)

(72) Inventor: Jack A. Ekchian, Belmont, MA (US)

(21) Appl. No.: 14/492,072

(22) Filed: Sep. 22, 2014

Related U.S. Application Data
(60) Provisional application No. 61/880,859, filed on Sep. 21, 2013.

(51) Int. Cl. B23B 31/28; B23B 45/02

(52) U.S. Cl. CPC B23B 31/28; B23B 45/02; B23B 2270/38
USPC 408/124; 173/46

(57) ABSTRACT

Power supplied by a power tool is used to induce a magnetic field in a tool piece attached to the power tool. The magnetic field is produced by an electromagnet coil and can be used to hold items such as screws in position on a tool piece such as a driver bit.

### CROSS-REFERENCE TO RELATED APPLICATIONS

This application claims priority of U.S. Provisional Patent Application No. 61/880,859, filed Sep. 21, 2013, entitled “Electric power tools” the contents of which are hereby incorporated herein by reference in their entirety.

### FIELD

The present invention generally relates to both corded and battery powered power tools. In particular, it relates to the inclusion of an electromagnet coil in a power tool in order to induce magnetic attraction between tool pieces attached to the power tool and other objects.

### BACKGROUND

Corded power tools and, more recently, battery powered tools, such as for example hand drills, reciprocating saws, impact drivers, electric screwdrivers, and rotary hammers, have become ubiquitous in industrial as well as residential settings. Such power tools include, for example, the Dewalt DWD112 corded drill/driver, the Milwaukee M12 cordless drill, the Dewalt DW292 impact driver and the Porter Cable Model 9748 reciprocating saw. Such tools are typically fitted with a tool piece such as, for example, a driver bit, a drill bit, a socket or a saw blade to perform various tasks. These tool pieces are typically held securely during use by tool piece holders such as, for example, a chuck, an anvil or a blade clamp.

A hand drill, corded or battery powered, is used with a drill bit to drill holes, or with a driver bit to drive screws. Frequently, bit holders are used to facilitate the use of driver bits. Bit holders may be fitted with permanent magnets that establish a magnetic field in the driver bit that is of sufficient magnitude to hold a screw in a proper orientation for driving into wood or other material. Without such a screw retention device, the screw typically needs to be held by hand before being driven. However, conventional magnetic bit holders have certain drawbacks including, for example: a) The bit holders typically add to the overall length of the drill. On occasions when the drill is being used in a tight space, the added length makes it difficult or impossible to, for example, drive a screw because of interference of the drill with surrounding objects. b) The magnets in conventional magnetic bit holders are permanent magnets. As a result, the magnetic attractive force of the bit holder is substantially constant. It cannot be adjusted or turned off. c) It is an added item that must be purchased and kept handy. Frequently, it is easily misplaced or lost. Also, an extra step is needed to install it in the chuck before the driver bit is installed. This may be a significant inconvenience.

### BRIEF SUMMARY

According to one or more embodiments of the invention, electromagnetic flux is electrically induced in a tool piece or accessory such as, for example, a driver bit, a drill bit or a saw blade, by using electrical energy from the power tool to which the tool piece is attached. Electromagnetic flux may also be produced in other ferromagnetic or paramagnetic objects that are not tool pieces, such as, for example, a steel rod, a nail, or a screw that may be secured by devices such as, for example, a chuck, a detent pin anvil or a blade clamp. The electromagnetic flux generated in such objects, such as a tool piece, is of at least sufficient magnitude as to produce a desired amount of magnetic attractive force between the objects secured to the power tool and other objects that are in close proximity to the secured objects.

The electromagnetic flux may be produced in the tool piece continuously whenever the power tool is connected to a power source such as a battery or electrical outlet. Alternatively, flux may be produced, for example, when the trigger of the power tool is partially or fully pulled or whenever a special device such as, for example, a special purpose switch is activated.

The magnetic field in the tool piece is preferably generated by using a dedicated electromagnet coil within the body of the power tool or in the tool piece holder, such as, for example, a drill chuck. Such an electromagnet coil may also be used to generate magnetic flux directly in the tool piece by using electrical power from the power tool. The electromagnet coil used for this purpose is preferably distinct from other coils in the power tool, such as for example, the electric motor of the power tool. The power supplied to the electromagnet coil may be constant or may be increased or decreased by the user to produce more or less magnetic attraction between the tool piece and other objects. The current supplied to the electromagnet coil may be direct current (DC) or any preferred form of alternating or time varying current.

According to another embodiment of the invention, an electromagnet coil is incorporated in the power tool as a stationary coil. The stationary coil is preferably configured with a paramagnetic core and, more preferably, with a ferromagnetic core, although core material that is at least partially non-magnetic may also be used. The magnetic core may be a special component incorporated specifically to form an electromagnet or may be a component of the power tool that also serves other functions. For example, the reciprocating spindle of a reciprocating saw or the rotating spindle of a hand drill which is attached to a chuck may be used as magnetic cores. Conventional power tool components, such as spindles, may be modified to accept such a coil. It is a yet further object of the invention to configure the electromagnet with a moving coil, such as a reciprocating or rotating coil. Electrical current may be supplied to a moving coil by, for example, using slip ring and brush combinations.

A magnetic field may also be induced in any paramagnetic or ferromagnetic material or device held in the tool piece holder or otherwise connected to an electric power tool. For example, a steel rod of any desirable length and appropriate diameter and shape can be accommodated in a tool piece holder such as a chuck. Such a rod may be magnetized by using an electromagnet coil in the body of the drill or the tool piece holder. The rod may then be used to reach into a hole or crevice and recover a component that is attracted by the magnetic field induced in the steel rod by using electric current from the power tool electrical supply.

According to a further embodiment of the invention, a tool piece configured with an electromagnet coil which can be energized by means of electrical contacts in the tool piece holder, when the tool piece is secured in the holder. For example, a driver bit may be configured with an electromagnet coil. This coil may be powered by means of electrical contacts in the chuck when the driver bit is secured properly in the chuck.

U.S. Pat. Nos. 4,137,490; 4,824,298; 5,526,460; 6,102,663; 8,376,667; and 8,459,372; and US Patent Applications 2011/0056714; 2009/0101379; 2012/0242048; and 2013/0082816, which describe power tool technologies, are incorporated herein by reference in their entirety.

Various features of the invention described herein may be used singularly or in combination with other features including features not described herein. The objectives indicated are not intended to be exhaustive.

### BRIEF DESCRIPTION OF THE DRAWINGS

The foregoing summary, as well as the description of the embodiments of the invention, will be better understood when read in conjunction with the appended drawings. For the purpose of illustrating the embodiments of the present inventions, and to explain their operation, drawings of preferred embodiments and schematic illustrations are shown. It should be understood, however, that the invention is not limited to the precise arrangements, variants, structures, features, embodiments, aspects, methods, advantages, improvements and instrumentalities shown, and the arrangements, variants, structures, features, embodiments, aspects, methods, advantages, improvements and instrumentalities shown and/or described may be used singularly in the device or method or may be used in combination with other arrangements, variants, structures, features, embodiments, aspects, methods and instrumentalities. In the drawings:

FIG. 1 shows a side view schematic of a battery powered drill configured according to one embodiment of the invention.

FIG. 2 shows a schematic of a circuit with an electromagnet powered by a battery, configured according to an aspect of the invention.

FIG. 3 shows a schematic of a circuit with an electromagnet powered by an alternating voltage power supply, configured according to an aspect of the invention.

FIG. 4 shows a schematic of a circuit for controlling an electromagnet and a power tool motor with a multi-position switch, configured according to an aspect of the invention.

FIG. 5a shows a schematic of the switch in FIG. 4 in fully open or neutral position. FIG. 5b shows a schematic of the switch in FIG. 4 in a first closed position. FIG. 5c shows a schematic of the switch in FIG. 4 in a second closed position.

FIG. 6 shows the schematic of an electromagnet with a rotating shaft as the magnetic core and a rotating coil connected to a power source by slip rings, configured according to an aspect of the invention.

FIG. 7 shows the schematic of a battery powered drill with a chuck configured according to another embodiment of the invention.

FIG. 8 shows the schematic of a battery powered drill with a chuck and drill bit configured according to still another embodiment of the invention.

FIG. 9a shows the schematic of a drill chuck and drill bit, configured according to an aspect of the invention. FIG. 9b shows a side view of the tool piece of FIG. 9a. FIG. 9c shows a top view of the tool piece of FIG. 9a.

### DETAILED DESCRIPTION

Certain exemplary embodiments will now be described to provide an overall understanding of the principles of the structure, function, manufacture and use of the devices and methods disclosed herein. One or more examples of these embodiments are illustrated in the accompanying drawings and described herein. Those of ordinary skill in the art will understand that the devices, methods and examples described herein and illustrated in the accompanying drawings are non-limiting exemplary embodiments and that the scope of the present invention is defined solely by the claims. The features illustrated or described in connection with one exemplary embodiment may be combined with features of other embodiments and that the features may be used individually, singularly and/or in various combinations. Such modifications and variations are intended to be included within the scope of the present invention.

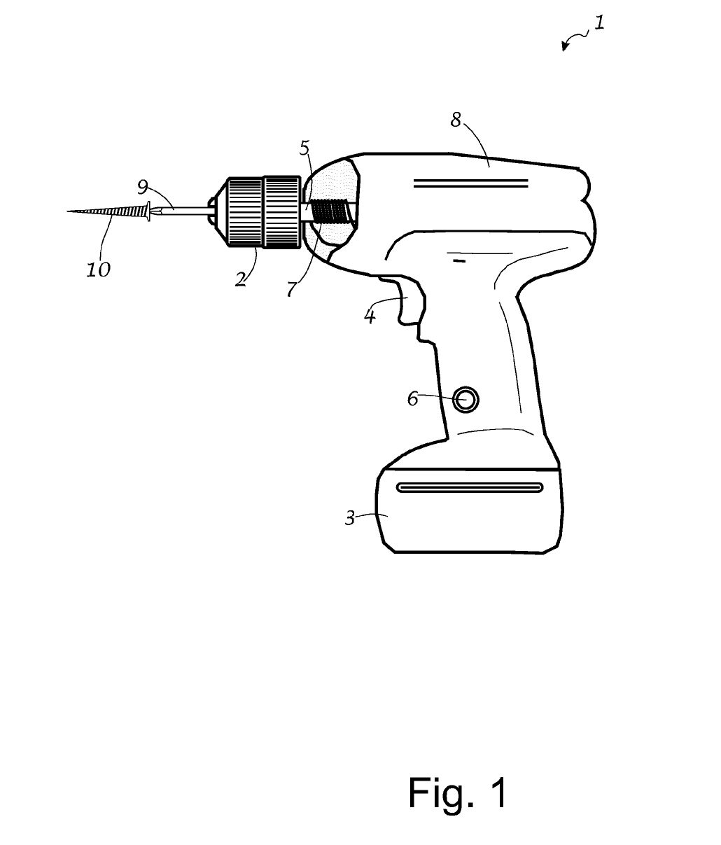

FIG. 1 illustrates a battery powered drill 1, configured according to an embodiment of the invention, comprising keyless chuck 2 and battery 3 with trigger 4. When the trigger 4 is depressed, electrical power is caused to flow to the electrical motor (not shown) which causes spindle 5 to rotate about its axis, thus turning the chuck 2.

Push button switch 6 is used to provide electrical power to electromagnet coil 7, located in the tool body 8 in order to produce magnetic flux in spindle 5. Preferably spindle 5 and chuck 2 are at least partially made of ferromagnetic material. When coil 7 is energized, a magnetic field is induced in a driver bit 9 held in chuck 2. The magnetic field induced in the driver bit, which may be a conventional driver bit, would attract and hold objects such as, for example, screw 10 in a proper position so it may be driven.

Alternatively a steel rod, or other paramagnetic or ferromagnetic object, may be held in chuck 2 in which case a magnetic field may be induced in those objects. It is preferred that driver bit 9 be made, at least partially, of steel or other paramagnetic material.

Switch 6 may also be configured to provide different amounts of electrical current to electromagnet coil 7 thus varying the amount of magnetic field produced in driver bit 9. For example, switch 6 may be connected to a linear or rotary potentiometer.

Coil 7 is stationary and is configured to surround spindle 5 but, preferably, not come into contact with the spindle allowing it to rotate freely.

Alternatively or additionally, trigger 4 may be used to provide electric power to the electromagnet coil 7. In such a configuration, trigger 4 would preferably be a multi-position switch. Trigger 4 may cause electrical current to flow to electromagnet coil 7 when the trigger is depressed over an initial portion of its overall travel. When depressed further, the trigger 4 also causes the speed of the motor of the drill 1 to vary. Alternatively or additionally, the electromagnet coil 7 may be placed in other locations, such as for example, within the chuck 2 or be attached or otherwise connected to the tool bit 9. Electromagnet coils may be located at multiple locations at one time.

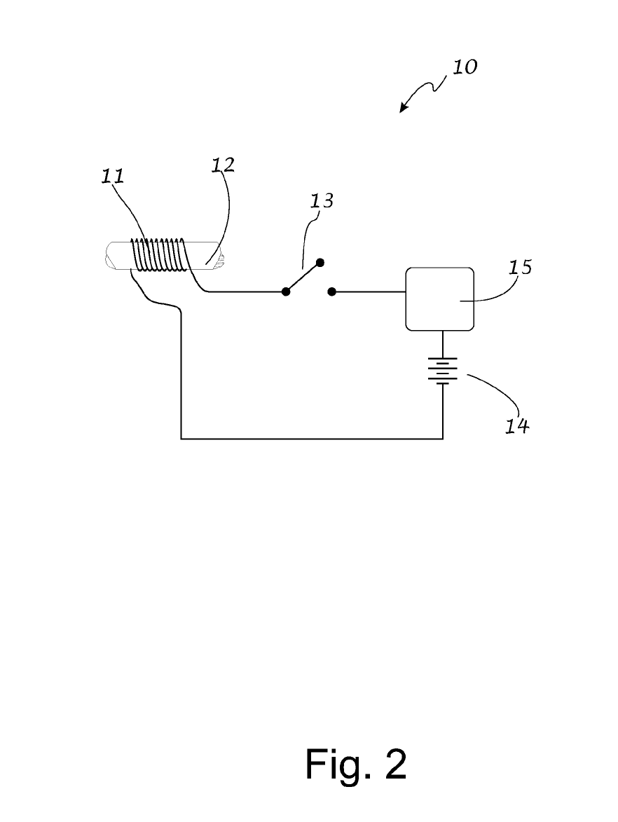

FIG. 2 shows an illustration of a circuit 10 configured to supply electric power to electromagnet coil 11 in order to create a magnetic field in core 12. Core 12 is preferably made, at least partially, of steel or other ferromagnetic material. However, it could alternatively be made, at least partially, of non-magnetic materials in which case the field in the coil may be weaker. When switch 13 is closed, current supplied by direct current source 14 flows through the circuit and produces a magnetic field along the longitudinal axis of the electromagnet coil 11. Magnetic core 12 may be, for example, the rotating spindle of a drill or the reciprocating spindle of a reciprocating saw. Coil 12 is stationary and preferably comprises a sufficient number of turns to produce the desired flux intensity or density in core 12. It is preferred that the coil 11 be of the smallest possible diameter where it does not touch core 12. Controller 15 may be used to regulate the voltage and amount of current supplied to coil 11 when switch 13 is closed.

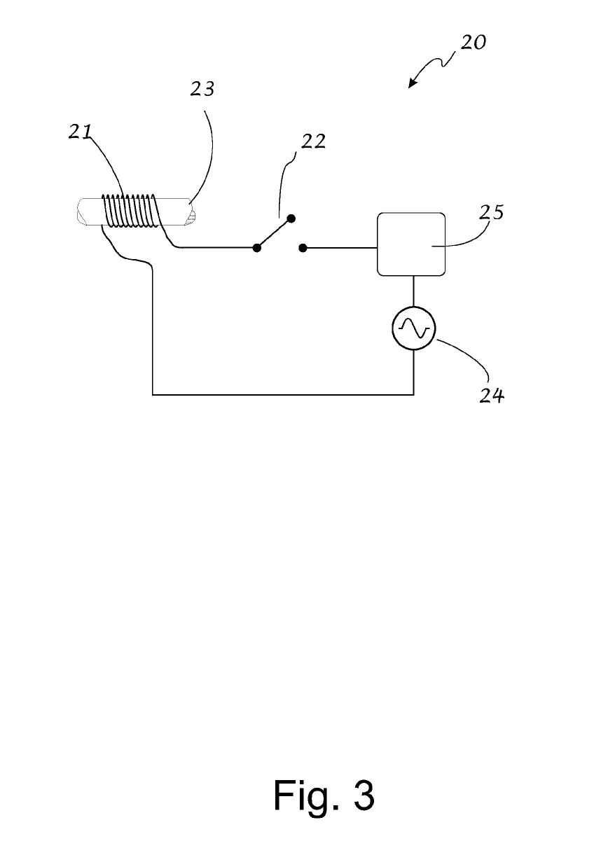

FIG. 3 shows an illustration of circuit 20 configured to supply alternating current to coil 21 when switch 22 is closed. Switch 22 may be a special purpose switch, such as switch 6 in FIG. 1, or be closed as a result of the motion of trigger 4 in FIG. 1. Current in coil 21 establishes an alternating magnetic field in core 23. It is preferable that the alternating magnetic field produced by coil 21 has a frequency of at least 60 cycles per second. Controller 25 may be used to regulate the magnitude and frequency of the voltage and current supplied to coil 21. The controller may also be used to rectify the voltage being supplied to the circuit.

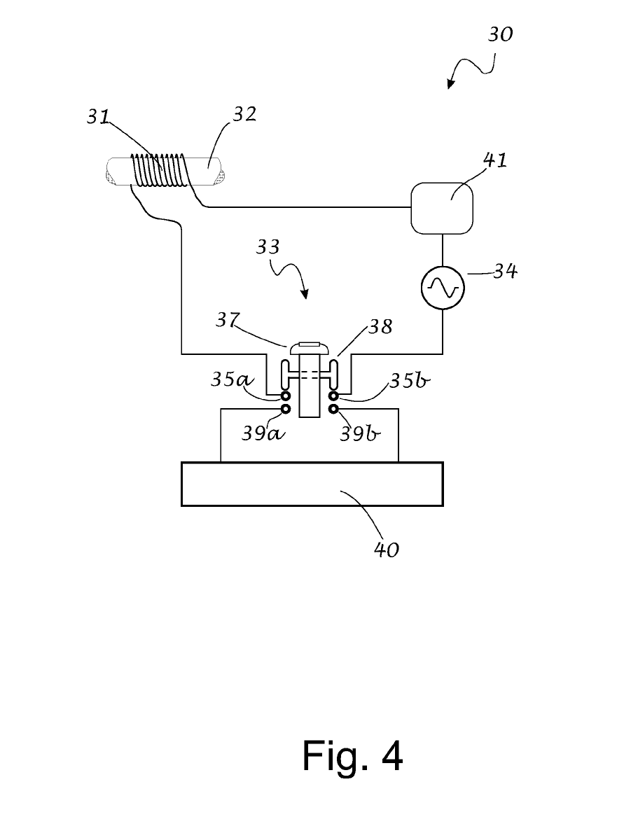

FIG. 4 shows an illustration of circuit 30 configured to supply electric current to coil 31 in order to produce a magnetic field in core 32. A multi-position switch is used to connect electric power source 34 to coil 31. When button 37 is in a first or neutral position, no current is supplied by the power source 34 to either coil 31 or the electric motor, represented by box 40, of the power tool. When button 37 of multi-position switch 33 is in a second position, it shorts terminal 35a and 35b by means of conductive bar 38. When the button 37 is moved to a third position, terminals 39a and 39b are electrically connected causing the electric motor of the power tool to also become energized. Trigger switch 4 in FIG. 1 may be configured to operate the multi-position switch 33. Controller 41 may be used to condition the power being supplied to electromagnet coil 31 and produce the desired voltage levels or profiles.

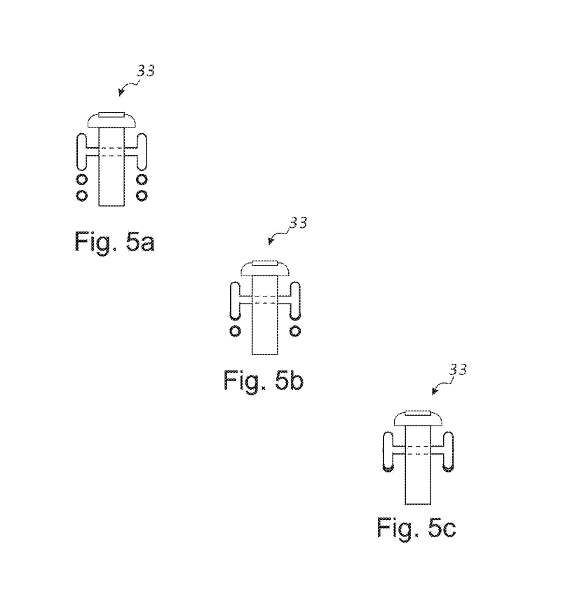

FIG. 5 shows an illustration of the multi-position switch shown in FIG. 4 in the three positions. FIG. 5a shows the switch in the neutral or open first position where neither the electromagnet coil nor the electric motor is energized. FIG. 5b illustrates the position of switch 33 where only the electromagnet coil is energized. FIG. 5c shows the position of switch 33 where both the coil 31 and the motor 40 shown in FIG. 4 are energized.

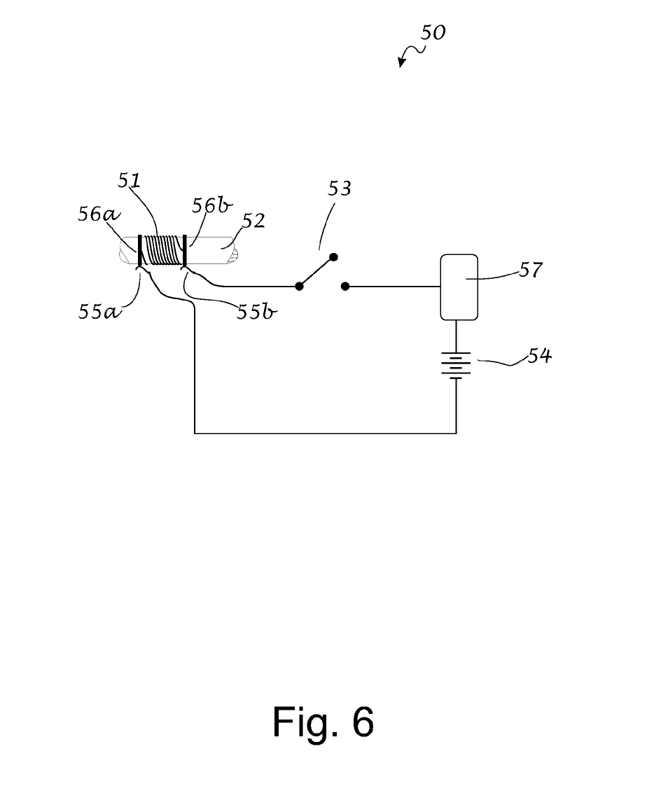

FIG. 6 shows an illustration of circuit 50 configured to supply electric current to electromagnet coil 51 in order to induce a magnetic field in core 52. When switch 53 is closed, the current supplied by direct current source 54 flows through the coil 51 by means of brushes 55a and 55b and rings 56a and 56b. Coil 51 and rings 56a and 56b are physically attached to core 52 and move with it. Controller 57 may be used to control the amount and characteristics of the power being supplied to coil 51.

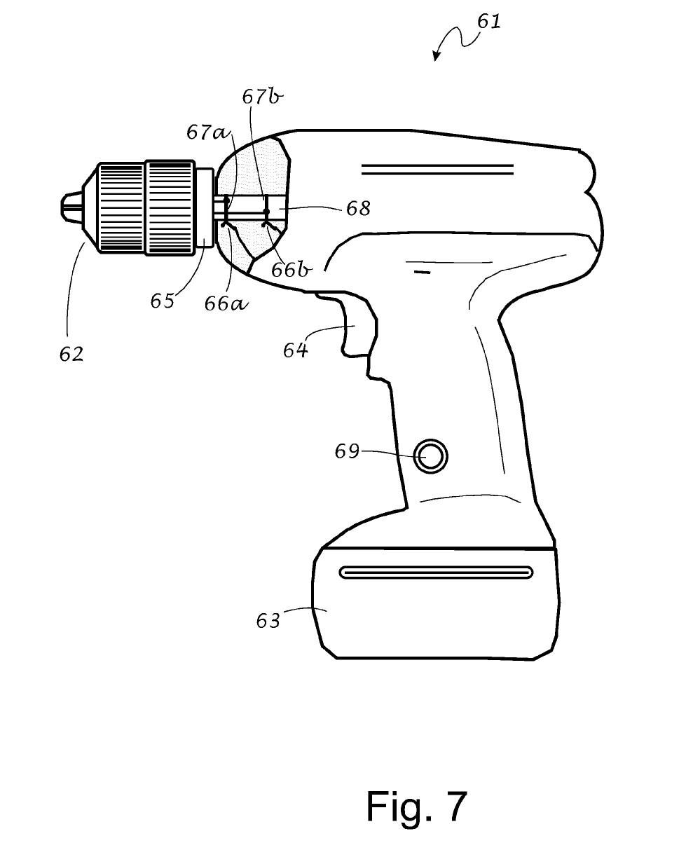

FIG. 7 illustrates battery operated drill 61 configured according to yet another embodiment of the invention. The drill comprises a chuck 62 and battery 63. Multi-position trigger 64 may be used to supply electrical power to coil 65 by means of brushes 66a and 66b and rings 67a and 67b mounted on spindle 68. Coil 65 may be attached to the chuck or the spindle, but is preferably enclosed within the chuck. When the trigger 64 is depressed up to approximately half of its maximum travel, it only supplies power to the coil 65 which induces a magnetic field in any paramagnetic or ferromagnetic material held in chuck 62. When trigger 64 is depressed beyond approximately 50% of its maximum travel, power is also supplied to the electrical motor (not shown) of the drill 61.

A switch 69 may be configured to cause electric power not to reach the coil 65 even when trigger 64 is depressed by any amount so that the drill may be used without generating a magnetic field by means of coil 65.

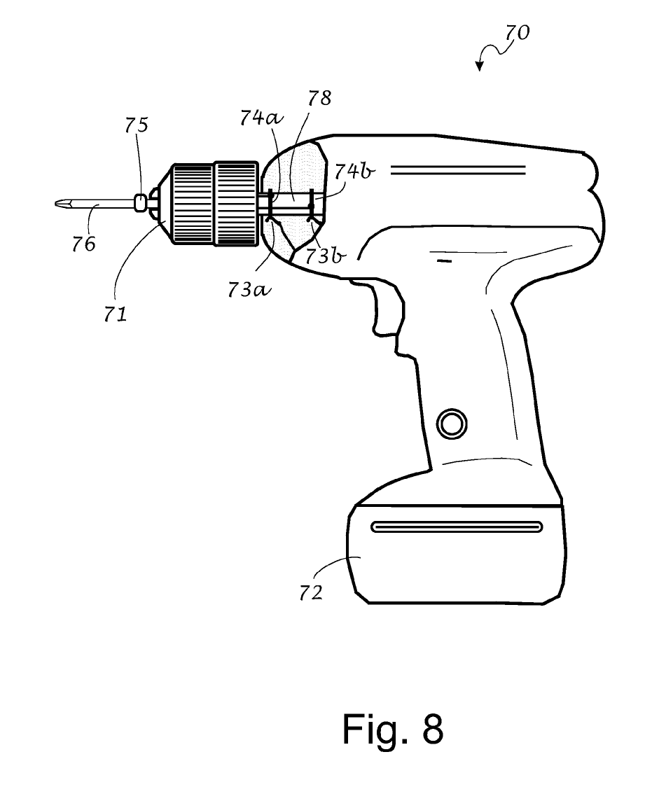

FIG. 8 illustrates a battery powered drill 70, configured according to another embodiment of the invention comprising a chuck 71 and battery 72. The drill 70 is configured with brushes 73a and 73b and rings 74a and 74b which supply electrical current by means of chuck 71 to a coil 75.

Electromagnet coil 75 may be permanently or detachably attached to driver bit 76. Alternatively, it may be attached or incorporated in a bit holder that is secured in chuck 71.

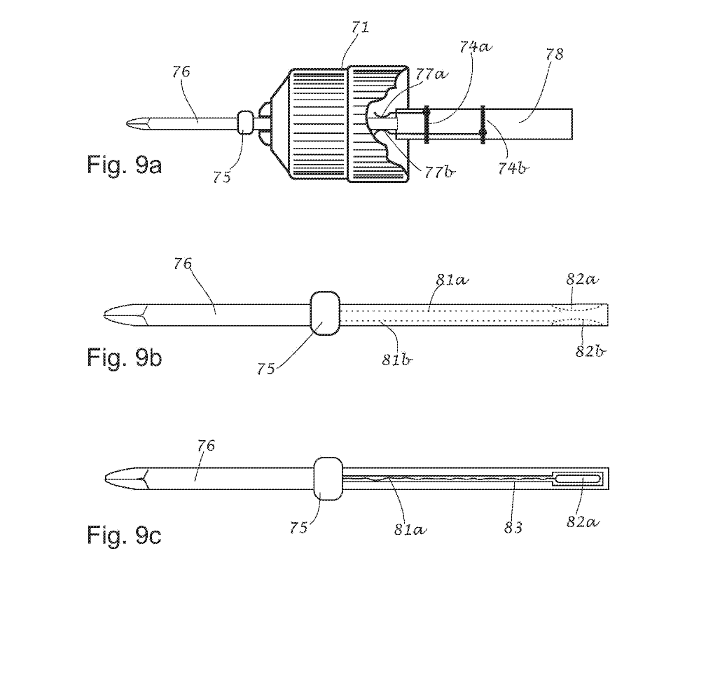

FIG. 9a shows an illustration of the chuck 71 of FIG. 8. Rings 74a and 74b are electrically connected to electrical terminals 77a and 77b respectively. Spindle 78 is connected to chuck 71.

FIG. 9b shows a side view illustration of driver bit 76 of FIGS. 8 and 9a comprising coil 75 and leads 81a and 81b. Electrical power is supplied to coil 75 by means of lead 81a and pad 82a and lead 81b and pad 82b. When driver bit 76 is secured in chuck 71, electrical terminals 77a and 77b are in electrical contact with pads 82a and 82b respectively.

FIG. 9c shows a top view illustration of driver bit 76 of FIGS. 8, 9a and 9b. Lead 81a electrically connects coil 75 to contact pad 82a (lead 81b and corresponding pad 82b are not shown), but is electrically insulated from the driver bit. Preferably, leads 81a and 81b and pads 82a and 82b are recessed from the cylindrical surface of driver bit 76 and configured such that the bit may be held in the jaws of the chuck without the leads becoming crushed.

The invention has been described in terms of functional principles and illustrations of specific embodiments. Embodiments described herein, including descriptions of the figures, are merely intended as exemplary, but the concept of the invention is not limited to these embodiments. The following claims are not limited to or by the described illustrative embodiments, figures, and stated objectives of the invention or the abstract. Furthermore, various presently unforeseen or unanticipated combinations of the disclosed embodiments, or their elements, or alternatives, variations or improvements which may become apparent to those of skill in the art are also intended to be encompassed by the following claims.

What is claimed is:

1) A power tool comprising:
a power tool body;
a tool piece holder;
an electromagnet coil configured to generate a magnetic field in a tool piece received in the tool piece holder.

2) The power tool in claim 1 wherein the power tool is an electric drill.

3) The power tool in claim 2 wherein the tool piece holder is a chuck.

4) The power tool in claim 2 wherein the electromagnet coil is housed in the tool body.

5) The power tool in claim 2 wherein the electromagnet coil is positioned outside the tool body.

6) The power tool in claim 5 wherein the electromagnet coil is attached to the tool piece holder.

7) The power tool in claim 5 wherein the electromagnet coil is attached to the tool piece.
